(19) United States
(12) Patent Application Publication
(10) Pub. No.: US 2024/0198513 A1
(43) Pub. Date: Jun. 20, 2024

(54) BIN-PICKING STATION WITH INTERNAL STORE

(71) Applicant: INORES GMBH, Steinhausen (CH)

(72) Inventor: Felix WEDE, Erding (DE)

(21) Appl. No.: 18/264,979

(22) PCT Filed: Feb. 7, 2022
(86) PCT No.: PCT/EP2022/052880

§ 371 Date: Aug. 10, 2023

(30) Foreign Application Priority Data
Feb. 10, 2021 (EP) 21156407.5

(51) Int. Cl. B25J 9/00; B25J 9/16; B65G 1/04

(52) U.S. Cl. CPC B25J 9/0093; B25J 9/1697; B65G 1/04

(57) ABSTRACT

A device for picking up a component from a container and transferring the component to a production side. The device includes a gripping robot, which is designed to pick up a component from the container and to place the component picked up from the container onto a transfer device. The device includes a controller and an internal store with at least one component receptacle for the interim storage of components. The gripping robot is designed to respond to a storage signal from the controller by placing the component picked up from the container onto the component receptacle of the internal store, and is also designed to respond to an acceleration signal from the controller by placing the component received by the internal store onto the transfer device.

### FIELD OF THE INVENTION

The invention relates to a device for automatically picking up a component from a container and transferring the component to a production side, the device comprising a gripping robot being configured to pick up a component from a container and placing the component picked up from the container onto a transfer device.

### BACKGROUND OF THE INVENTION

From the state of the art, in particular from automotive production, it is known to use production robots that can pick up ordered components and process then on a production table. The production robots are located on a so-called production side, which must not be entered by workers for safety reasons. The underlying problem thus consists in feeding the components to the robot in an ordered manner without the need of workers entering the production side.

Usually, this is solved by physically separating the feeding site from the production side, for example by a protective fence, and providing a so-called accumulation conveyor from the feed side through the protective fence to the production side. In such a structure, the production plant can be provided with a container holding components, a so-called components bin, on the feed side, which contains the components in a disordered manner. A production worker may then take several components from the component bin and place them onto special pallets of the accumulation conveyor in an ordered position. The accumulation conveyor or a similar device may then move the ordered components through the protective fence to the production side, where they can be picked up by the production robot and processed.

To automate the process, known further developments provide that the production worker is replaced by an automated station or cell, a so-called bin-picking station or bin-picking cell. Such bin-picking stations are closed units meeting all safety regulations and machine guidelines. Such bin-picking stations thus precisely automate the act of picking components from the component bin and placing components onto the special pallets of the accumulation conveyor.

In order not to cause any delay in production, the average cycle time of the bin-picking station must be shorter than the average cycle time of the production robot. The average cycle time of the bin-picking station refers to the average time per component that the bin-picking station needs for picking up a component from the bin, optionally subjecting it to a quality control, and placing it onto the accumulation conveyor, or in general onto a transfer unit. The average cycle time of the production robot refers to the average time per piece that the production robot needs for picking up a component from the accumulation conveyor, or in general from a transfer unit, and installing it on the production table. Simply speaking, the bin-picking station must work faster than the production robot in order not to slow it down.

The bin-picking stations known from the state of the art in general also achieve an average cycle time that is lower than the cycle time of the production robot, so that it seemed that this problem was generally solved. However, in practice it has been shown that it still happened sometimes that the production robot had to wait for components. This phenomenon is caused by the bin-picking station having a high variance in picking times or control times, respectively, of the components. Since the components are disordered in the bin, some parts can be picked up quickly, while others take more time because they are, for example, picked up in an unfavorable manner. The quick and slow picking times are averaged out to achieve to lower cycle time mentioned above, however, there might be problem cases when several unfavorably picked components are processed successively, which leads to a temporary lack of components for the production robot.

EP 2 952 296 A2 discloses a bin-picking station with the aim of placing components taken from a bin onto a target location. A first robot places the workpieces taken from the bin onto an intermediate station, and a second robot can then pick the workpieces up from the intermediate station and move them to the target location. The intermediate station serves to increase the spectrum of possible gripping positions, which is why the intermediate station has differently configured tool holders.

### SUMMARY OF AN EXAMPLE EMBODIMENT OF THE INVENTION

It is the object of the invention to overcome the problems of the state of the art and to create a bin-picking station, i.e., a device for picking up a component from a container and transferring the component to a production side, which does not only have a short average cycle time, but can also avoid a temporary lack. Furthermore, the system should be simplified as far as possible, and the number of required sensors should be reduced.

This object is achieved by a device for picking up a component from a container and transferring the component to a production side, wherein the device comprises a gripping robot, which is configured to pick up a component from a container and to place the component picked up from the container onto a transfer device, wherein the device has a controller and an internal store with at least one component receptacle for the interim storage of components, wherein the gripping robot is configured, after receiving a storage signal from the controller, i.e., after changing into a storage mode, to place the component picked up from the container onto the component receptacle of the internal store, and wherein the gripping robot is also configured, after receiving an acceleration signal from the controller, i.e., after changing into an acceleration mode, to pick up a component from the component receptacle of the internal store and to place the component received by the internal store onto the transfer device.

According to the invention, a storage mode and an acceleration mode can be created by means of the internal store. In the storage mode, the device can do some work “in advance”, when it would otherwise pause. In storage mode, components are picked up from the container as in normal operation and optionally subjected to a quality control. However, instead of placing the components onto the transfer device, they are placed in the internal store. If there is a short-term need for components on the transfer device or on the production robot, the device can switch to acceleration mode. In acceleration mode, the gripping robot picks up components from the internal store and places them onto the transfer device. Because the components are on component receptacle in the internal store, they are in a predefined position, which allows components to be placed onto the transfer device faster in acceleration mode than in normal mode, where components must be picked from an unknown position.

Furthermore, a quality control of the components, for example by means of a camera or specially designed sensors in the device, can already be carried out in the storage mode, so that all components located in the internal store have already been subjected to a quality control, which is therefore not necessary in the acceleration mode, which may further increase the speed in acceleration mode.

The device according to the invention thus creates the advantage that the acceleration mode achieves a temporary reduction in cycle time. Thus, even short-term cycle time increases in the normal operating mode can be compensated for by sending the acceleration signal to the gripping robot, as a result of which the production robot can be operated more stably than according to the state of the art.

In order to identify particularly efficiently whether a specific component receptacle in the internal store is occupied or not, the device can include an evaluation unit, a camera connected to the evaluation unit, and a light spot under each of the component receptacles of all component carriers, with a respective light spot being recognizable by the camera when the respective component receptacle is unoccupied and being unrecognizable by the camera when a component is present on the respective component receptacle on the respective component receptacle, the evaluation unit being configured to recognize a component receptacle as occupied or covered when a respective light spot is visible or not in the picture taken by the camera. This solution has the advantage that the evaluation unit must only have one control input for receiving the picture from the camera. The evaluation of the picture taken by the camera as to whether light spots are visible in the picture or not can be implemented comparatively easily.

This solution is particularly useful in connection with the internal store, since it can be configured without separate sensors. If a separate sensor was arranged under each component receptacle, this would require a large number of sensors and a large number of control inputs on the evaluation unit, which in turn would require complicated evaluation at great expense. Compared to such solutions, the solution according to the invention thus has the advantage that only the picture from the camera has to be evaluated.

The controller is preferably configured to send the storage signal to the gripping robot when the transfer device is fully loaded. A fully loaded transfer device usually indicates the beginning of a pause, allowing the device to use this period of time to fill the internal store with components. Alternatively or additionally, it could be provided that the controller receives a signal about the availability of the production robot. For example, the internal store can be loaded before the production robot starts working.

In a further preferred embodiment, the controller is configured to send the acceleration signal to the gripping robot when a component can be placed onto the transfer device and at least one component is located in the internal store. The device can thus place each component in the internal store onto the transfer device at the next opportunity in order to load it as quickly as possible, as a result of which temporary cycle time increases can be compensated in advance.

Alternatively or in addition to the aforementioned embodiment, it can be provided that the controller is configured to send the acceleration signal to the gripping robot when a temporary reduction in the cycle time of the device is required. In this way, the device can be operated in normal operation for as long as possible until a need arises. The internal store can thus be used as a fallback option, which is only accessed in an emergency. This can reduce the overall working time and thus the energy requirements compared to the aforementioned embodiment.

In order to keep the device longer in the acceleration mode, the internal store can have at least five, preferably at least ten, preferably at least thirty component receptacles. The internal store can particularly preferably have at least as many component receptacles as components can be placed onto the transfer device at the same time. As a result, for example, a whole pallet can be fully loaded onto the transfer device in acceleration mode, after which the device can switch back to storage mode until the next pallet is ready on the transfer device.

Also preferably, the internal store has at least two differently configured component receptacles for different types of components. This can be used, for example, to process two components in parallel in the device, i.e., to bring two containers with different components into the device and to place both types of components onto the transfer device, wherein the storage mode and the acceleration mode can be used for both components. However, the internal store with two different component receptacles can also be helpful when the device only processes one type of component. For example, the internal store can be used for a first period of time for components of a first type and for a second period of time for components of a second type without modifying the device 1.

In order to make the internal store structurally particularly simple and also modular, the internal store can comprise at least one or at least two component carriers that are preferably arranged parallel to one another and on which component receptacles are arranged linearly.

The transfer device used in connection with the device can be an accumulation conveyor with a conveyor belt or a production buffer comprising at least two pivotable component carriers, each of which comprises at least two additional component receptacles for receiving a component, wherein the component carriers are each pivotable about axes parallel to one another and pivotable from a loading position, in which components can be placed onto the component receptacles by the gripping robot, into an unloading position, in which the components can be removed from the production side. The production buffer is advantageous because it is cheaper than an accumulating conveyor and also saves space.

Also preferably, all light spots of a component carrier can be illuminated by a single light source, preferably an LED strip, and each can be formed by openings in the area of the component receptacles, wherein each component carrier preferably comprises an additional opening through which the light source is visible, even if all component receptacles are occupied by components. This enables a simple functional check of the light source without having to remove a component from the component carrier.

Also preferably, the device comprises a housing or barrier, wherein the gripping robot is enclosed by the housing and the container is insertable into the device via an insertion opening. As a result, a particularly safe and closed device can be created, since the gripping robot is not accessible from the outside and does therefore not represent a source of danger.

Overall, a system comprising the aforementioned device and a production robot located on the production side can be created, the production robot being configured to pick up components from the transfer device, the production robot preferably having an average normal cycle time that is higher than an average production cycle time of the device.

### BRIEF DESCRIPTION OF THE DRAWINGS

FIG. 1 shows a system with a manual work station, an accumulating conveyor, and a production robot according to the prior art.

FIG. 2 shows an inventive device in a first perspective view.

FIG. 3 shows the device of FIG. 2 in a second perspective view.

FIG. 4 shows a first embodiment of an internal store.

FIG. 5 shows a second embodiment of an internal store.

FIG. 6 shows a schematic interior view of the inventive device.

FIG. 7 shows a particular embodiment of a component carrier of the internal store of FIG. 4 in detail.

### DETAILED DESCRIPTION OF SOME EXAMPLE EMBODIMENTS

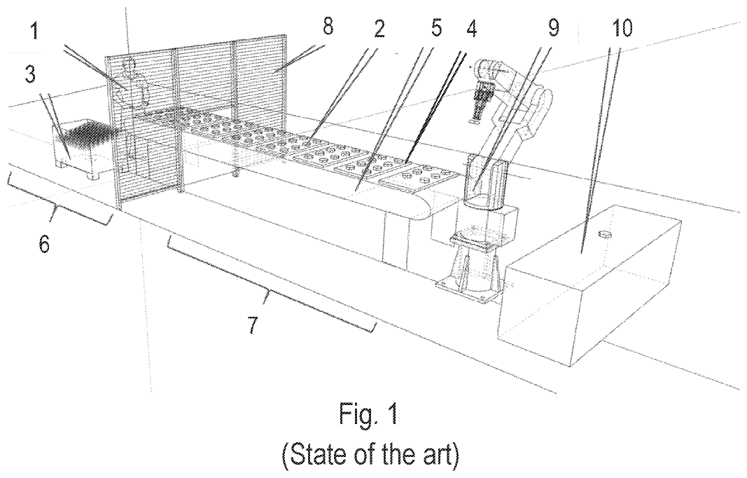

FIG. 1 shows a system known from the state of the art, in which a production worker 1 removes components 2 from a container 3 and places them in an ordered position onto a special pallet 4 of an accumulating conveyor 5. The components 2 are disordered in the container 3 and must therefore be brought into the correct position manually by the production worker 1 before they are placed onto the pallet 4 of the accumulating conveyor 5.

The accumulating conveyor 5 moves the now ordered components 2 on the pallet 4 from the feed side 6, on which the production worker 1 is working, to the safety-critical production side 7, where staff are not allowed to enter. The feed side 6 is separated from the production side 7 by a protective fence 8. On the production side 7, there is a production robot 9 which picks up the components 2 ordered on the pallet 4 and processes them on a production table 10. This system is particularly common in the automotive industry.

It is known to replace the production worker 1 by a so-called bin-picking station or cell reaching into the container 3 by means of a gripping robot to pick up a component 2, optionally subjecting it to a quality control, bringing it into the correct position and placing it onto the pallet 4 of the accumulating conveyor 5. The mechanics and control of the device described below, in particular the general techniques for picking up disordered components 2 from the container 3 and bringing the components 2 into a predetermined position, are known per se from the state of the art.

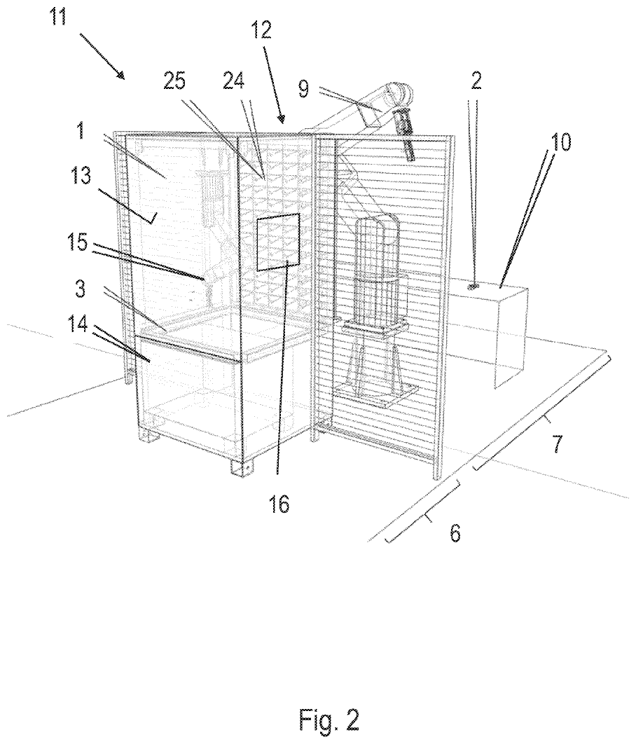

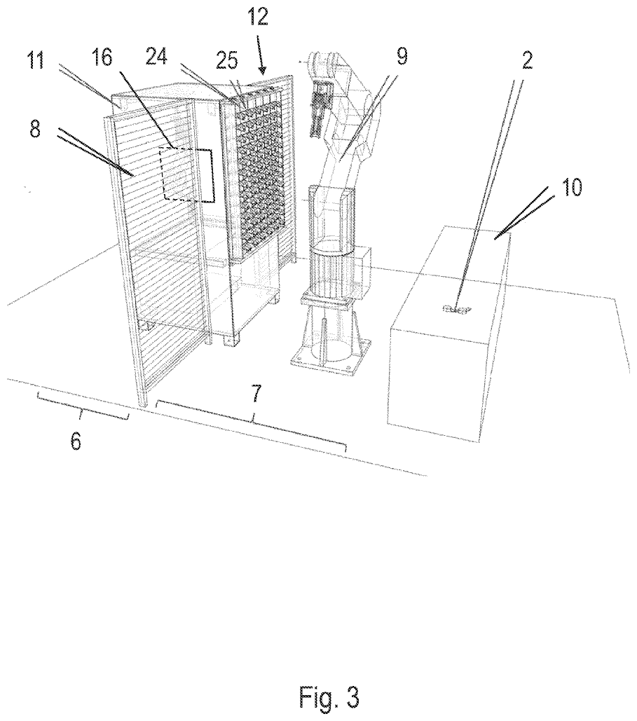

According to the invention, a device 11 is provided as shown in FIGS. 2 and 3, i.e., a bin-picking station having an internal store 16 in order to compensate for short-term peaks in the cycle time. Below; the device 11 will be described in detail, wherein, in particular, the components 2, the container 3, the feed side 6, the production side 7, the protective fence 8, the production robot 9, and the production table 10 are unchanged compared to the embodiment of FIG. 1 are therefore provided with the same reference numbers.

The device 11 comprises a housing 13 with an opening 14, wherein the container 3 with the components 2 can be manually or automatically inserted through the opening 14 from the walk-in feed side 6. A gripping robot 15 with a gripping arm is provided inside the housing 13, which is configured to remove components 2 from the container 3 inserted into the device 11 and place them in an ordered position onto a transfer device 12 configured as a production buffer, which is described in detail below. Alternatively, the transfer device 12 could also be configured as a generally known accumulating conveyor 5.

The internal store 16 can, for example, have a size of 900×1000 mm and can be located on a side wall of the device 11, which could have a floor area of 1 m², for example. An internal store 16 of this size allows the storage of 50 to 100 components 2, depending on the component size. The total requirement of the system including the device 11 and the production robot 9 is approximately 2 m².

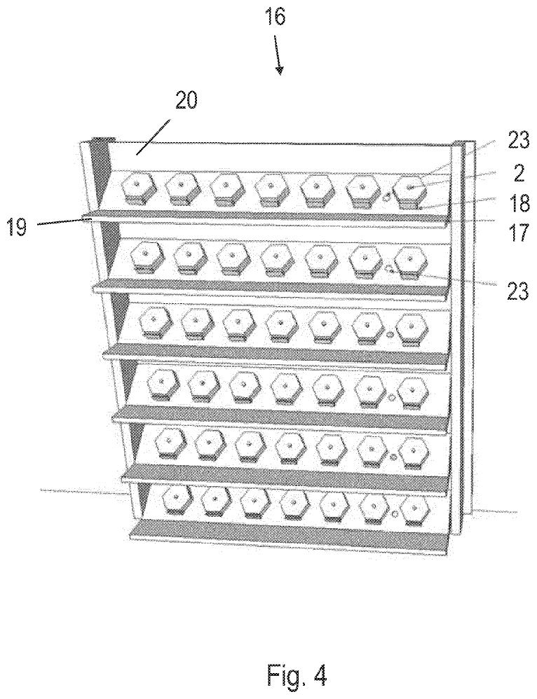

FIG. 4 shows the internal store 16 in detail, which in the illustrated embodiment has six component carriers 17 with seven component receptacles 18 of the same design for temporarily storing components 2. The component carriers 17 are rigidly mounted in the device 11, for example on a side wall of the device 11, can, however, be modular, i.e., exchangeable. The component receptacles 18 can, for example, include one or more centering pins and/or position adaptors for the component 2 in order to ensure the correct positioning of the components 2 on the component carrier 17. The shape of the component receptacle 18 and the mutual distance between two component receptacles 18 on a component carrier 17 is generally dependent on the shape and the dimensions of the component 2 to be placed. There are usually two to thirty, preferably four to fifteen, component receptacles 18 on a component carrier 17. Also, the number of component carriers 17 can essentially be selected as desired, preferably between two and fifteen, particularly preferably between four and ten. The internal store 16 can particularly preferably have a total of at least five, preferably at least ten, preferably at least thirty component receptacles 18. The internal store 16 could also have at least as many component receptacles 18 as components 2 can be placed onto the transfer device 12 at the same time.

Depending on the application, the component carriers 17 can be mounted horizontally, vertically or obliquely in a frame or on a wall surface inside the device 11. As shown in FIGS. 4, 5 and 7, the component carriers 17 can, for example, be L-shaped profiles, which have, for example, a first carrier wall 19 and a second carrier wall 20, with the component receptacles 18 being arranged in a spandrel between the carrier walls 19, 20.

It is obvious that the internal store 16 could also be structured differently, e.g., by mounting the component receptacles 18 in an array directly on a plate, e.g., a side wall of the device 11. In particular, however, the component carriers 17 enable a modular configuration of the component receptacles 18 so that, for example, a component carrier 17 with component receptacles 18 can be exchanged for another component carrier 17 with other component receptacles 18.

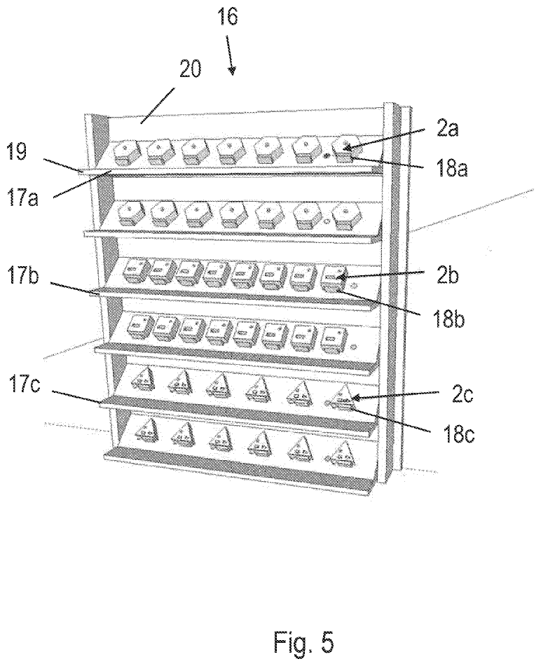

Thus, in a first embodiment (FIG. 4), the internal store 16 can be configured to temporarily store only one type of component 2. I.e., all components 2 have the same dimensions and are manufactured in essentially the same way, so that all component receptacles 18 are also manufactured in the same way. In one embodiment (FIG. 5), however, several containers 3 could be introduced into the device 11, in each of which different components 2 with different dimensions are supplied, so that, e.g., the first container 3 contains components 2 with first dimensions and the second container 3 contains components 2 with second dimensions. It can be seen that it may be necessary to adapt component receptacles 18 to the different components 2 if the component receptacles 18 are not configured as universal component receptacles for components 2 of different dimensions. For example, the internal store 16 can include at least one first component carrier 17a having first component receptacles 18a, onto which components 2a with first dimensions can be placed, and at least one second component carrier 17b having second component mounts 18b, onto which components 2b with second dimensions can be placed. FIG. 5 also shows a third component carrier 17c including third component receptacles 18c, onto which components 2c with third dimensions can be placed. Alternatively or additionally, a component carrier 17 could be used that includes both at least one first component receptacle 18a, onto which components 2 with first dimensions can be placed, and at least one second component receptacle 18b, onto which components 2 with second dimensions can be placed.

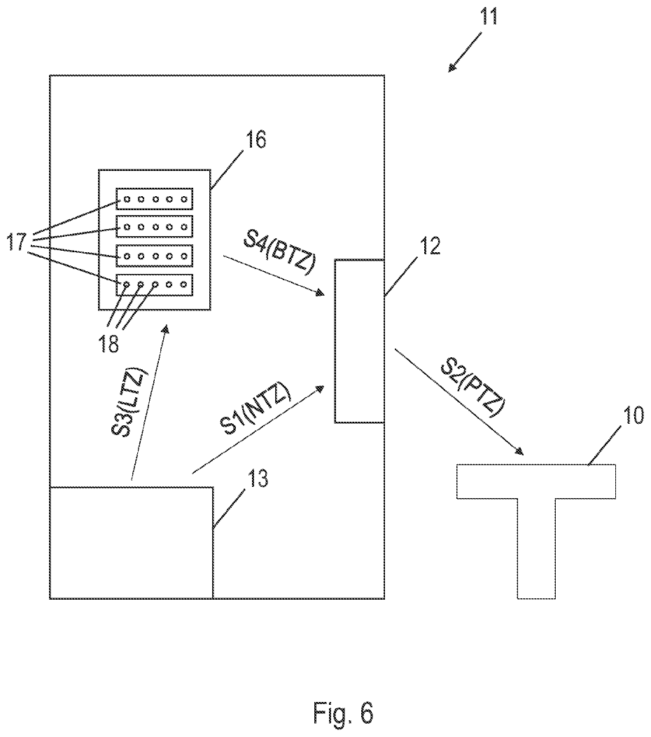

The use of the internal store 16 in the device 11 will now be explained in more detail with reference to FIG. 6. In a normal operation, which is also carried out in the state of the art, the gripping robot 15, not shown in this figure, picks up a component 2 from the container 3 and moves the component 2 on the path S1 to the transfer device 12. As soon as components 2 are available on the transfer device 12 for the production robot 9 (not shown in this figure), it moves the components 12 on the path S2 from the transfer device 12 to the production table 10) and installs them there.

The device 11 has an average normal cycle time NTZ, which refers to the average time per component 2 that the device 11 needs to pick up a component 2 from the container 3, optionally subject it to a quality control, and place it onto the transfer device 12. The average normal cycle time NTZ of the device 11 is subject to high variance, which is due to the fact that the components 2 are present in the container 3 in a disordered manner and there are repeatedly difficulties in picking up the components 2. In addition, a quality check may also have to be repeated several times, or if the quality check recognizes a defective component, a new component 2 must be picked up.

The production robot 9 has an average production cycle time PTZ, which refers to the average time per piece that the production robot 9 needs to pick up a component 2 from the transfer device 12 and install it on the production table 9. The production cycle time PTZ is extremely constant, i.e., the variance of the individual processing times of the components 2 by the production robot 9 is low. This is inter alia due to the fact that the production robot 9 can pick up components 2 from the transfer device 12 in a predetermined position and all processing steps on the production table 10 are carried out in the same way.

For the production robot 9 to work continuously, the average normal cycle time NTZ of the device 11 should be below the average production cycle time PTZ of the production robot 9, so that in the best case, the production robot 9 always has a component 2 on the transfer device 12 available. Due to the high variance of the average normal cycle time NTZ of the device 11, however, it can happen that there is a temporary deficiency, e.g., if several components 2 that are difficult to pick up come one after the other. For this reason, the internal store 16 is provided.

Since the average normal cycle time NTZ of the device 11 is below the average production cycle time PTZ of the production robot 9, the device 11 has on average a period of time, PTZ-NTZ, during which the device 11 would stand still. This period of time, PTZ-NTZ, in which the device 11 would normally pause, is used to pick up a component 2, in a “storage mode”, from the container 3 on a path S3 and to place it onto a component receptacle 18 of the internal store 16. The average storage cycle time LTZ, which refers to the average time per component 2 that the device 11 needs to pick up a component 2 from the container 3 and store it in the internal store 16, is essentially the same as the normal cycle time NTZ of the device 11, because there is also a component 2 being picked up from an undefined position and optionally being subjected to a quality control.

In order to increase the loading speed of the device 11 onto the transfer device 12, the components 2 are now not picked up from the container 3 as usual, but are picked up in an “acceleration mode” on a path S4 from the component receptacles 18 of the internal store 16 and placed onto the transfer device 12. The average acceleration cycle time BTZ, which refers to the average time per component 2 that the device 11 needs to pick up a component 2 from the internal store 16 and place it onto the transfer device 12, is extremely short and has little variance because the gripping robot 15 can pick up the components from a predefined position and there are hardly any relevant external influences. In particular, the quality control can already be carried out in the storage mode before the component 2 is stored in the internal store 16, so that this time is also saved in the acceleration mode. In summary: production cycle time PTZ>normal cycle time NTZ=storage cycle time LTZ>acceleration cycle time BTZ.

Depending on the application, it can be selected when to carry out the storage mode or the acceleration mode. The storage mode is usually carried out when the transfer device 12 is fully loaded, i.e., when the device 11 cannot place any additional components 2 onto the transfer device 12 at a certain time. This is usually determined by a controller which, for example, receives and evaluates a picture of the transfer device 12 taken by a camera or receives a corresponding sensor signal, for example from a light barrier sensor. If the controller determines that the transfer device 12 is fully loaded, it sends a storage signal to the gripping robot 15 so that it switches into storage mode.

In general, it can be freely selected when the device 11 switches to the acceleration mode. For example, the acceleration mode can be switched on as soon as at least one component 2 can be placed onto the transfer device 12 and at least one component 2 is located in the internal store 16. As a result, the transfer device 12 can always be loaded as quickly as possible. If the controller detects these conditions, it sends an acceleration signal to the gripping robot 15 so that it switches to the acceleration mode.

Alternatively or additionally, it can be provided that the acceleration mode is switched on when the controller detects a potential upcoming problem, i.e., when a temporary reduction in the cycle time of the device is required. This can be the case if, for example, the normal cycle time NTZ of the last X components was equal to or greater than the production cycle time PTZ or than a predetermined threshold value, wherein X is a predetermined number, for example 3, 5 or 10. The controller can also identify a potential problem more precisely, for example if the controller receives information from the production robot 9, e.g., about when the next components 2 are needed.

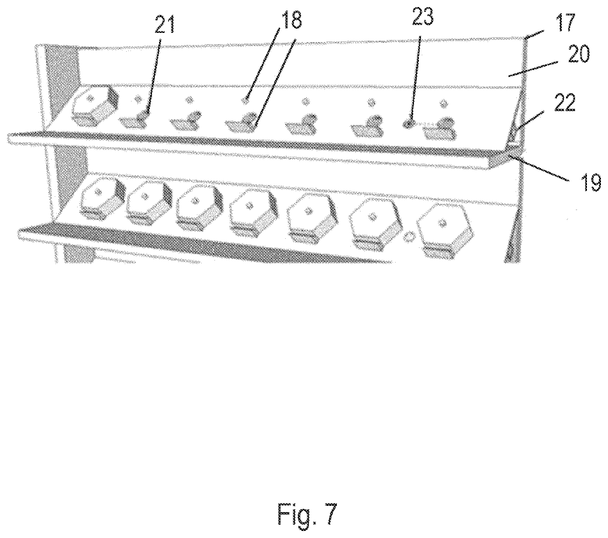

FIG. 7 shows a particularly advantageous option by means of which the device 11 can determine whether a component 2 is located on a component receptacle 18. As can be seen on the upper, largely unfilled component carrier 17, there is a light spot 21 under each of the component receptacles 18, which can be seen by a camera (not shown) when there is no component 2 on the respective component receptacle 18. However, if a component 2 is placed onto a component receptacle 18, the associated light spot 21 is covered. By recognizing a light spot 21, the mentioned camera or an evaluation unit connected to it can determine whether the associated component receptacle 18 is occupied or not. The evaluation unit can send this information to the control unit mentioned above. The light spots 21 could, of course, also be used in the case the component carrier 17 is an array of component receptacles 18, in which case the light spots 21 could also be present as an array.

In the embodiment of FIG. 7, all light spots 21 are illuminated by a common light source, here a LED strip 22, wherein an opening, e.g., a bore, is provided in the component carrier 17 for each light spot 21 through which the LED strip 22 is visible. All light spots 21 of the component carrier 17 are thus illuminated by a single light source. The embodiment with the LED strip 22 is particularly preferred when the light spots 21 are arranged linearly, e.g., with linearly arranged component receptacles 18. A plurality of LED strips 22 could also be provided for a single component carrier 17, for example if the component carrier comprises an array with light spots 21.

In the aforementioned embodiment, an additional opening 23 can be provided in the component carrier 17 through which the light source is visible in order to generate a control light. The additional opening 23 is provided on the component carrier 17 in such a way that the control light is visible even when all component receptacles 18 are occupied by a component 2. This means that the functioning of the light source can be checked at any time. If the control light was not present, it would not be possible to distinguish whether all component receptacles 18 are occupied by a component 2 or whether the light source is not working. The component carrier 17 may include only one of the additional openings 23 mentioned, for example if the component carrier 17 has only one light source, e.g., a LED strip 22. The component carrier 17 may also include several of the additional openings 23 mentioned, e.g., if it comprises several light sources, e.g., LED strips 22. For example, the component carrier 17 may include one additional opening 23 per light source, so that there is a control light for each light source.

As an alternative to the aforementioned embodiment, in which the presence of a component 2 on a component receptacle 18 is determined by detecting a visible or non-visible light spot 21 in the picture from a camera, the presence of a component 2 can also be detected using a programmable logic controller (PLC) with conventional sensors. The conventional sensors are, for example, light barriers, capacitive or inductive sensors. A purely mechanical detection of components 2 on the component receptacles 18 is also possible.

In general, the transfer device 12 is configured to receive a plurality of components 2 and to transfer them from the device 11 to the production side. As mentioned above, the transfer device 12 can, for example, be configured as an accumulation conveyor 5. According to the FIGS. 2 and 3, however, the transfer device 12 can also be a production buffer, which comprises at least two pivotable additional component carriers 24, each of which comprises at least two additional component receptacles 25 for receiving a component 2, the component carriers 24 each being pivotable around axes A parallel to one another and pivotable from a loading position, in which components can be placed onto the component receptacles 18 by the gripping robot 15, into an unloading position, in which the components 2 can be removed from the production site 7. In this embodiment, the component carriers 24 can each be pivoted about horizontal or vertical axes. Furthermore, the axes can be in a common vertical plane or in a plane that is inclined relative to the vertical plane. The additional component carriers 24 can also be elongated, preferably L-shaped, profiles on which the additional component receptacles 25 are arranged linearly.

1-14. (canceled)

15. A device for picking up a component from a container and transferring the component to a production side, the device comprising:
a gripping robot, which is configured to pick up a component from the container and to place the component picked up from the container onto a transfer device,
a controller and an internal store with at least one component receptacle for the interim storage of components,
wherein the gripping robot is configured to respond to a storage signal from the controller by picking up a component from the container and by placing the component picked up from the container onto the component receptacle of the internal store, and
is configured to respond to an acceleration signal from the controller by picking up a component from the component receptacle of the internal store and by placing the component picked up from the internal store onto the transfer device,
the device further comprising an evaluation unit, a camera connected to the evaluation unit, and a light spot under each of the component receptacles, with a respective light spot being recognizable by the camera when the respective component receptacle is unoccupied and being unrecognizable by the camera when a component is present on the respective component receptacle on the respective component receptacle,
wherein the evaluation unit is configured to recognize a component receptacle as occupied or not occupied when a respective light spot is visible or not in the picture taken by the camera.

16. The device according to claim 15, wherein the controller is configured to send the storage signal to the gripping robot when the transfer device is fully loaded.

17. The device according to claim 15, wherein the controller is configured to send the acceleration signal to the gripping robot when a component can be placed onto the transfer device and at least one component is located in the internal store.

18. The device according to claim 15, wherein the controller is configured to send the acceleration signal to the gripping robot when a temporary reduction in the cycle time of the device is required.

19. The device according to claim 15, wherein the internal store has at least five, preferably at least ten, preferably at least thirty component receptacles.

20. The device according to claim 15, wherein the internal store has at least as many component receptacles as components can be placed onto the transfer device at the same time.

21. The device according to claim 15, wherein the internal store has at least two differently configured component receptacles for different types of components.

22. The device according to claim 15, wherein the internal store has at least one or at least two component carriers that are preferably arranged parallel to one another and on which component receptacles are arranged linearly.

23. The device according to claim 15, further comprising the transfer device that is configured as an accumulation conveyor with a conveyor belt.

24. The device according to claim 15, further comprising the transfer device being configured as a production buffer comprising at least two pivotable additional component carriers, each of which comprises at least two additional component receptacles for receiving a component, wherein the additional component carriers are each pivotable about axes parallel to one another and pivotable from a loading position, in which components can be placed onto the additional component receptacles by the gripping robot, into an unloading position, in which the components can be removed from the production side.

25. The device according to claim 24, wherein all light spots of a component carrier are illuminated by a single light source and each is formed by openings in the area of the component receptacles, wherein each component carrier comprises an additional opening through which the light source is visible, even if all component receptacles are occupied by components.

26. The device according to claim 15 comprising a housing, wherein the gripping robot is enclosed by the housing and the container is insertable into the device via an insertion opening.

27. A system comprising a device according to claim 15 and a production robot located on the production side, which is configured to pick up components from the transfer device.

28. The system according to claim 27, wherein the production robot has a normal cycle time that is higher than an average production cycle time of the device.
